(19) United States
(12) Patent Application Publication
(10) Pub. No.: US 2026/0201688 A1
(43) Pub. Date: Jul. 16, 2026

(54) PORTABLE TANK FOR LIQUID HANDLING

(71) Applicant: LKQ Corporation, Antioch, TN (US)

(72) Inventor: Robert W. Touton, Antioch, TN (US)

(73) Assignee: LKQ Corporation, Antioch, TN (US)

(21) Appl. No.: 19/021,076

(22) Filed: Jan. 14, 2025

(51) Int. Cl. E03F 1/00; B60R 15/04; E03F 7/08; E03F 7/10

(52) U.S. Cl. CPC E03F 1/008; E03F 7/08; E03F 7/10; B60R 15/04

(57) ABSTRACT

A tank may be provided for handling a liquid such as waste water in storage, transport, and offloading modes with a body having a handle at a front end and wheels at a rear end, and an interior volume for receiving the liquid in the storage mode. The interior volume of the surface may provide for storage of the liquid with the weight of the liquid concentrated adjacent the rear end of the body, and the weight of the liquid remains concentrated adjacent the rear end of the body as the user lifts the handle into the transport mode. The tank may include top and/or side gauges to provide the user with a visual indication of a level of the liquid in the tank for aid in determining when to transition from the storage mode to the transport mode.

### FIELD OF THE INVENTION

The present invention relates to a tank to receive, transport, and offload liquids, for tasks such as transferring waste water from a recreational vehicle or trailer to a waste-receiving station. The tank may include a shell with a hollow interior that provides for balanced shifting into a transport mode by a shape that concentrates the weight of the liquid over a rear axle that is opposite a front-end handle. The tank may provide at least one threaded opening for receiving a replaceable fitting to couple to an inlet hose and/or an outlet hose. The opening and the fitting may each include cooperating sets of teeth and pockets for secure but reversible installation of the fitting in the opening. The tank may include one or more gauges providing visual indication of the level of liquid in the tank.

### BACKGROUND OF THE INVENTION

Portable waste tanks have been available with various structures for use with RVs. The tanks typically consist of a hollow plastic shell with a handle at one end and a pair of wheels at an opposite end, with the hollow shell having a uniform shape between the handle and the wheels. A similar version of portable waste tanks includes two pairs of wheels, one at a rear end and the other at a front end adjacent the handle. The plastic shells typically are molded with integral fittings at openings for coupling to inlet hoses and/or outlet hoses. The tanks are filled in a horizontal position, and, when believed to be ready for transport, are lifted at the handle by the user and pulled with only the rear wheels in contact with the ground in the version with one pair of wheels. The user typically detaches the inlet hose when the tank is believed full and transports the tank to an offloading site, where the user attaches the outlet hose. The versions with two pairs of wheels are typically transported by pulling on the handle with all four wheels on the ground. The user typically estimates the fill level of the tanks by peering into the openings with the hoses removed. However, several problems, unrecognized and unsolved in the prior art, exist with such tanks.

A first problem is that, as the tank fills in the horizontal position, the uniform shape of the tanks distributes the weight of the liquid evenly between the handle end and the wheeled end. When the user lifts the handle to commence transport with the two-wheeled version, an initial issue is that the liquid's weight being evenly distributed makes the tank difficult to lift at the handle. Then, as the user is lifting at the handle, the weight of the liquid shifts toward the wheeled end, which may cause the tank to skate away from the user's hand and/or to push the handle upwards. This initial motion may cause the user to attempt to counteract, resulting in the liquid sloshing back toward the handle, all of this causing an overall discomfort and lack of control for the user over the waste-filled tank. A second problem is that the inlet hoses are repeatedly removed and reinstalled each time the user transports waste, resulting in wear to the integral fittings. Another issue with fittings on the existing tanks is that they may require an adapter for use with a typical hose, e.g., a garden hose. If these fittings fail, the entire tank becomes useless for its intended purpose. A third problem is in the user being unable to reliably and easily determine the level of liquid in the tank, and the requirement to remove the inlet hose and peer into the opening brings the user into close proximity of the waste water in the tank, which is unpleasant.

The present disclosure recognizes and solves the problems with the prior art by providing a portable tank with a shape that, as the tank fills in the horizontal position, initially concentrates the weight of the liquid in a volume that is centered on and close to the rear axle for the wheels. The result of such concentration is that the user, in lifting the handle for transport, will not be changing the distribution of the weight of the liquid relative to the rear axle. Thus, the tank and handle do not undergo rearward or upward movements and the handling is comfortable. An improvement is realized over a range of fill levels from a lightly filled condition to a completely filled condition. In the more-filled and completely filled conditions the weight of the liquid is evenly distributed horizontally and its center of gravity moves as the handle is lifted to be around the rear axle thereby making the handle easier to lift, particularly in the heavier, more difficult conditions. The present disclosure also provides for the openings in the tank shell for inlet hoses to have fittings that, on the one hand, are securely installed, and on the other hand, are also replaceable when that is needed. The present disclosure provides a swivel fitting that is conveniently adapted for connection to a garden hose. The present disclosure further provides for one or more externally viewable indications of the level of liquid in the tank.

### BRIEF DESCRIPTION OF THE DRAWINGS

FIG. 1 is a 3D view of a tank in accordance with an embodiment of the present disclosure, the tank including a plastic shell with hollow interior, a handle adjacent a front end and a pair of wheels on an axle adjacent a back end, a small opening and a large opening into the interior through a top portion of the tank, each opening including a fitting for hose connection, the tank shell providing a shape for the interior with a major portion of the volume close to the axle adjacent the back end, the shape further illustrated by dashed hidden lines.

FIG. 2 is a view of the tank similar to that of FIG. 1, shown with a wheel on a near side removed and with hidden lines not visible, the wheel removed to further show the shape of the shell of the tank, including in the area adjacent the axle.

FIG. 3 is a 3D view of a tank in accordance with another embodiment of the present disclosure, the tank including a plastic shell with hollow interior, a removable handle adjacent a front end and a pair of wheels on an axle adjacent a back end, with caps installed over each of a small opening and a large opening into the interior through a top portion of the tank, a top fuel gauge installed in the top portion, and a pair of side fuel gauges in a side wall of the tank, the tank shell providing a shape for the interior with a major portion of the volume close to the axle adjacent the back end, the shape further illustrated by dashed hidden lines.

FIG. 4 is a view of the tank similar to that of FIG. 3, shown with a wheel on a near side removed and with hidden lines not visible, the wheel removed to further show the shape of the shell of the tank, including in the area adjacent the axle.

FIG. 5 is a side view of only the shell of the tank as in FIG. 1, further showing the shape of the shell having less height close to the handles and more height in the area in front of and to the rear of the axle.

FIG. 6 is the tank of FIG. 1, tilted up to a position used for emptying the tank through the large opening on the top portion of the tank, the view rotated partially to show both the side and top portion of the tank.

FIG. 7 is a top view of the tank of FIG. 1, further illustrating an embodiment for the handle formed integrally with the tank and also the fittings installed at the small opening and the large opening into the tank interior.

FIG. 8 is a top view of the tank of FIGS. 3 and 4, illustrating an embodiment for the handle of the tank that is attached to the shell of the tank and also a hook useful for mounting the tank, when not in use, to a ladder on the back of an RV, and also the caps installed over the small opening and the large opening into the tank interior and the top fuel gauge installed in the top portion.

FIG. 9 is a top view similar to the view of FIG. 8, with only the tank shell and also a fitting installed in the large opening without the cap in place, showing attachment points in the front end of the shell for attaching the handle, and the small opening also shown without the cap in place, and an opening where the top fuel gauge would be installed.

FIG. 10 is a close-up side view of the tank of FIGS. 3-4 and 8-9, showing a fitting installed over the small opening and the cap installed on the fitting.

FIG. 11 is a close-up side view of the tank of FIG. 1, showing a fitting installed over the small opening and with a threaded swivel installed on the fitting.

FIG. 12 is an exploded view of the fitting and swivel as shown in FIG. 11, illustrating the assembly for the fitting, and also showing attachment points for a strap for an additional connection between a cap and the fitting.

FIG. 13 is an underside view of the fitting of FIGS. 11 and 12, showing a pair of the raised teeth that, when the fitting is screwed into the opening, engage with the indented pockets that surround the opening for a ratcheted securement of the fitting into the opening.

FIG. 14 is another close-up view of the installed fitting as in FIG. 11, shown from a rear perspective.

FIG. 15 is a close-up side view of the tank of FIGS. 3-4 and 8-9, showing a fitting installed over the large opening and the cap installed on the fitting, and also showing the fuel gauge installed in the top portion of the tank.

FIG. 16 is an exploded view showing the large opening with the associated fitting above it, illustrating how the fitting may be screwed into place and showing indented pockets surrounding the opening that correspond to raised teeth in the fitting for ratcheting together the fitting and the opening to secure against inadvertent loosening of the fitting.

FIG. 17 is an underside view of the fitting of FIG. 16, showing a pair of the raised teeth that, when the fitting is screwed into the opening, engage with the indented pockets that surround the opening for a ratcheted securement of the fitting into the opening.

FIG. 18 is the fitting of FIGS. 16 and 17 secured in place in the opening.

FIG. 19 is another exploded view of the fitting for the large opening from a lower viewing angle as compared to FIG. 16 to show an o-ring in place in the opening to provide a watertight seal between the fitting and the opening.

FIG. 20 is a 3D view of the small opening, without the fitting, showing the circle of indented pockets surrounding the threaded opening.

FIG. 21 is a 3D view of the large opening, without the fitting, showing the circle of indented pockets surrounding the threaded opening.

FIG. 22 is a close-up view of the tank as shown in FIGS. 3-4, showing the location of the structures providing the top fuel gauge and the two side fuel gauges.

FIG. 23 is a 3D view of just the structure of the top fuel gauge as it would be installed in the tank.

FIG. 24 is a 3D exploded view of the structure of the top fuel gauge of FIG. 23.

FIG. 25 is a 3D view of just the structure of one of the side fuel gauges as it would be installed in the tank.

FIG. 26 is a 3D exploded view of the structure of the side fuel gauge of FIG. 25.

### DETAILED DESCRIPTION

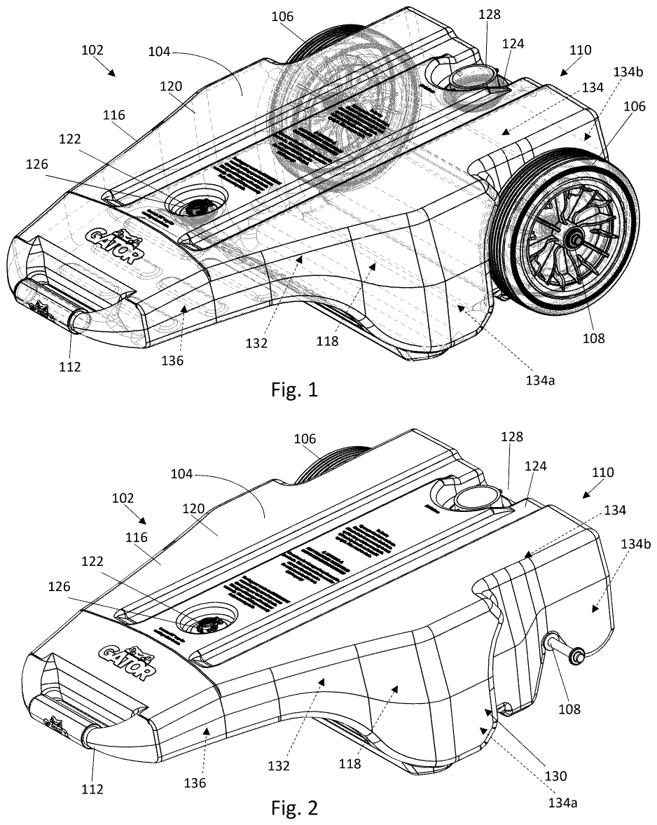

As shown in FIGS. 1-4, embodiments of a tank 102 in accordance with the present disclosure may include a body 104, a pair of wheels 106 on an axle 108 adjacent a rear end 110 of body 104, and a handle 112 adjacent a front end 114 of body 104. Body 104 may be formed as a plastic shell 116 with a hollow interior 118 where the waste water will be stored. A top portion 120 of tank 102 may include one or more openings, such as a small opening 122 and a large opening 124 into interior 118 through which the waste water may be received. For example, small opening 122 may be used to receive grey water and large opening 124 may be used to receive black water from an RV, trailer, or other vehicles. Typically, large opening 124 is used for offloading waste water to a waste-receiving station, although the size, location, and use of the openings may vary as desired for optimal operation of a tank for a particular application.

Small opening 122 may include a fitting 126 for a hose connection. Large opening 124 may include a fitting 128 for a hose connection. The fittings and hose connections are discussed in greater detail below.

Body 104 of tank 102 may provide a shape 130 for interior 118 defining a volume 132 for receiving and storing the liquid waste. Shape 130 may include a major portion 134 of volume 132 close to axle 108. Major portion 134 may include subportions 134a and 134b located fore and aft, respectively, of axle 108. A minor portion 136 of volume 132 may be located close to handle 112. Shape 130 is one example of how tank 102 may provide for balanced shifting into a transport mode. In this example, shape 130 concentrates the weight of the waste water or other liquid over rear axle 108 opposite front-end handle 112. Other shapes for, or configurations of body 104 may be provided for this distribution of the weight. Preferably, as is the case for shape 130 in the embodiments of FIGS. 1-4, the concentrating of the weight of the liquid is realized over a range of fill levels from a lightly filled condition through midranges to a completely filled condition, as will be further discussed below.

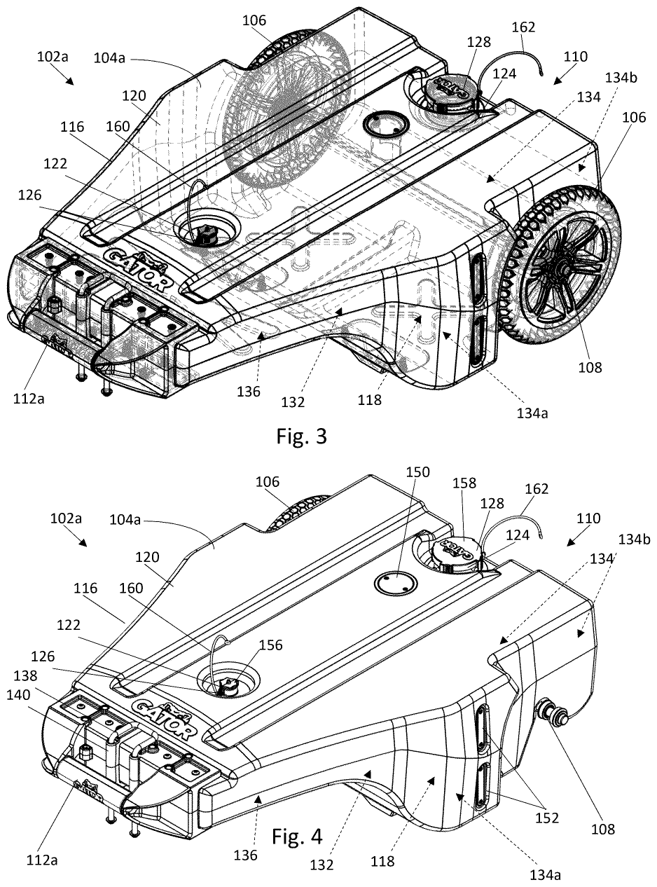

A tank 102a as depicted in FIGS. 3-4 is generally similar in structure to the embodiment of FIGS. 1-2 and may include a handle 112a that is separately attached to a body 104a, as opposed to the handle 112 of FIGS. 1-2, which may be integrally formed with the rest of body 104. Any of the embodiments of tanks in the present disclosure may be scaled to any size as best suited for a particular application for the tank. For example, tank 102 of FIGS. 1-2 may be any suitable size, such as in a range from about 16 gallons in volume through about 23 gallons, and tank 102a of FIGS. 3-4 may be formed in a larger size, such as about 29 gallons or greater. The separate construction of handle 112a with suitable connection hardware to body 104a may be advantageous in sizes in the larger range.

As also seen in FIGS. 3-4, tank 102a may include a hook 138 that may be selectively moved along slides 140 between a recessed position, as seen in FIGS. 3-4, to an extended position. When tank 102a is not in use, hook 138 may be extended for use in suspending tank 102a from a horizontal bar, such as a rung of a ladder on an RV body.

Either of tanks 104, 104a may be made in whole or in part with any suitable process, for example, using a plastic material formed with a molding process, such as injection, extrusion, and/or blow molding. While shape 130 generally defines smooth surfaces for shell 116, for an optimal volume for a given surface area and material, one or more variations may be included in shell 116, for purposes such as strengthening the shell and/or providing externally useful features. For example, both tanks 102, 102a include a pair of recessed channels 142 extending along top portion 120 from rear end 110 towards front end 114 and may provide added longitudinal strengthening of shell 116. Similarly, multiple channels 144, 144a may be provided in tanks 102, 102a respectively, for example in a lower portion 146 of the tank, having various shapes and directions as best suited for strengthening for a particular application of the tank.

Tanks 102, 102 a may also include a raised foot 148 or pair of feet 148a, respectively, in lower portion 146. Feet 148, 148a may support a stable horizontal position for the tank.

As also seen in FIGS. 3-4, the tank may be provided with one or more gauges to provide the user with a visual indication of a level of liquid in the tank. Typically the tank is made of a substantially opaque material. The tank may include a top gauge 150 and/or one or more side gauges 152 and each may include a substantially clear or translucent window, which will be discussed in more detail below, allowing a view of the liquid in the tank for purposes of determining when the tank needs to be disconnected from the waste water and transported and offloaded.

FIGS. 3 and 4 also illustrate a pair of caps 156, 158 over the openings 122, 124 in top portion 120. Each cap may be screwed, latched, or otherwise affixed to the respective fitting in a manner which the user may release as necessary to provide access through the openings. Caps 156, 158 may each be leashed to the tank by a strap 160, 162 that may be tethered to the tank by any suitable means to keep the cap in proximity with the tank while it is receiving and/or offloading waste water.

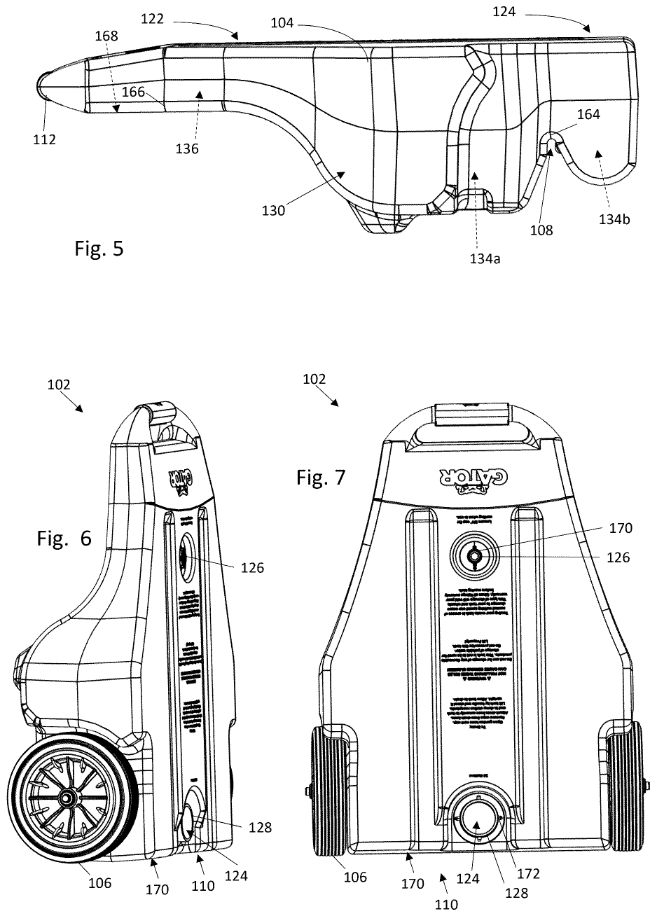

FIG. 5 shows the tank in a side view with the wheels removed further to illustrate shape 130 concentrating the weight of the liquid close to the rear axle over a range of fill levels from a lightly filled condition through midranges to a completely filled condition. With the tank empty and ready to be filled, liquid entering at opening 122 routes into subportion 134a located fore of axle 108. Liquid entering at opening 124 routes into subportion 134b aft of axle 108. Shape 130 thus, in the case of using both openings, provides for balancing the weight over axle 108. If more liquid is applied through one opening rather than the other, the weight of the liquid is at least close to the rear axle in the lightly filled condition, and in a partially filled condition, the liquid will flow over a ledge 164 between the subportions 134a, 134b, thus keeping the weight close to axle 108. As best seen in FIG. 5, ledge 164 may be positioned to be lower than a shelf 166 that defines a lower surface 168 of minor portion 136 that is closer to the handle. Thus, as the level of liquid progresses from the midrange-filled condition to a completely filled condition, shape 130 and the relative positions of ledge 164 and shelf 166 concentrates the weight of the waste water or other liquid over rear axle 108 opposite the front-end handle. As noted above, this is an example of how the tank may provide for balanced shifting into a transport mode.

As may be seen in FIG. 6, the tank may include at rear end 110 a substantially flat surface 170, which may be coplanar (see also FIG. 7) with the rear of wheels 106 to provide a stable position for the tank when it is tilted up to empty liquid out of the tank through large opening 124. Typically, the user transports the tank to a waste-receiving station and attaches a receiving hose provided by the station to fitting 128 at opening 124. When the user tilts the tank up to the position shown in FIG. 6, the liquid in the tank is drained by gravity out the opening 124. The user may also attach a clean water supply hose to fitting 126 at opening 122 and, during and after the emptying of the tank, may apply clean water through opening 122 to rinse out the inside of the tank.

Fittings 126, 128 are shown in FIG. 7 in place and without caps 156, 158. Fittings 126, 128 may be selected to be compatible with the environment in which the tank will be used. As an example, fitting 126 may include a swivel-type coupler 170 with an internal thread configured to receive an external thread such as that of the effluent end of a garden hose. Such a coupler may be compatible with both the effluent end of the grey water hose typically provided with an RV and the clean-out hose provided at the waste water receiving station. Similarly, fitting 128 may include a bayonet-style coupler 172, which may be compatible with the effluent end of the black water hose of an RV and the affluent end of the receiving hose at the waste water station.

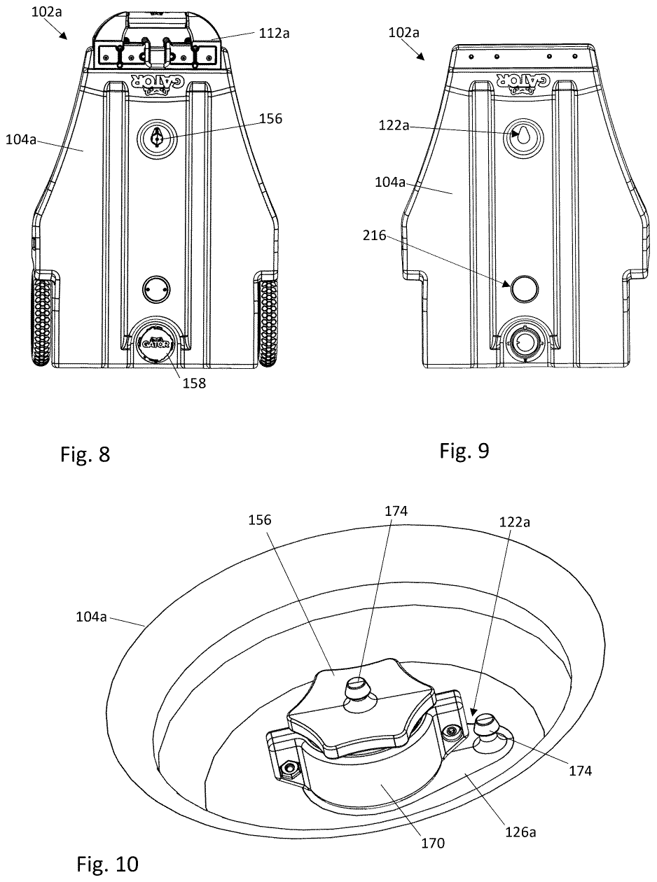

As described above for FIGS. 3 and 4 and further illustrated by FIGS. 8 and 9, tank 102a may include a handle 112a that is attachable by hardware and removable and replaceable. Caps 156, 158 are also shown in FIG. 8, illustrating this for both of tanks 102, 102a.

As best seen in FIGS. 9 and 10, body 104a of tank 102a may include an alternative opening 122a, e.g., one with a tear drop shape. A corresponding fitting 126a may be installed in opening 122 and include a coupler suited to a particular application, such as swivel coupler 170. Cap 156 and fitting 126a may each include an anchor 174 for attaching strap 160 (FIGS. 1 and 2) to maintain the proximity of the cap to the tank when removed from the fitting. Similar anchors may be used on the other fittings, including those of tank 102.

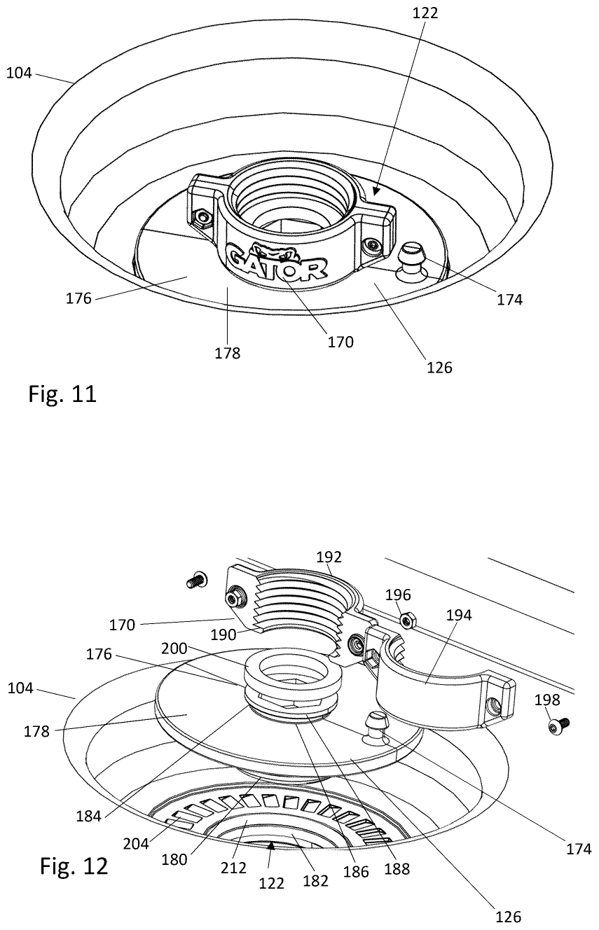

As best seen in FIGS. 11-14, fitting 126 may include swivel coupler 170 and a base 176 with strap anchor 174. Base 176 may include a plate 178 configured to cover opening 122, and an external threaded portion 180 below plate 178 configured to be coupled to an internal thread 182 of opening 122. Above plate 178, base 176 may include a structure 184 with a neck 186 and a broader rim 188 above the neck configured to capture a corresponding rim 190 of swivel coupler 170. As particularly illustrated in FIG. 12, swivel coupler 170 may be manufactured in two halves 192, 194 that may be attached together by nuts 196 and bolts 198 or other suitable hardware and/or manufacturing techniques such as ultrasonic welding to capture rim 190 under rim 188 while still allowing rotation of the coupler. A washer or O-ring 200 may be placed on top of rim 188 to be compressed against the end of the garden hose when swivel coupler 170 is tightened on the hose for a watertight seal.

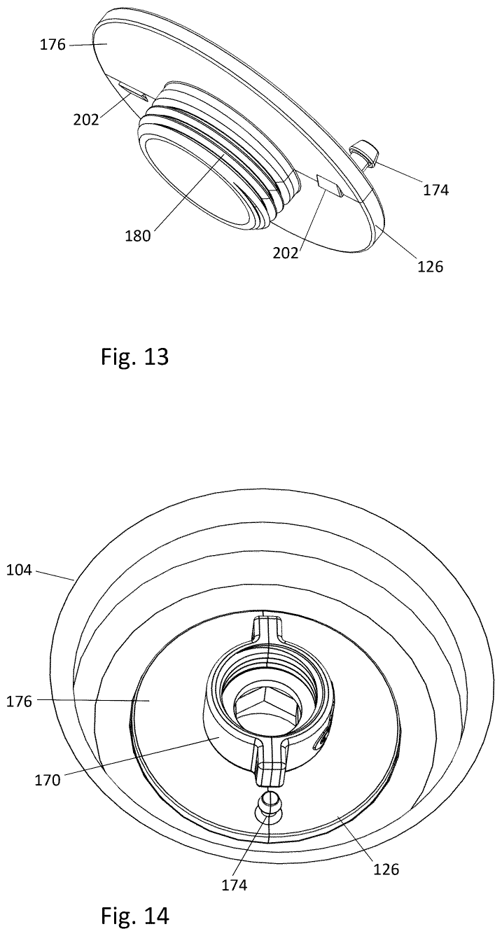

Opening 122 and fitting 126 may further include cooperating sets of teeth and pockets, e.g., a pair of ramped teeth 202 on fitting 126 (FIG. 13) and an annular set of ramped pockets 204 (FIG. 12) surrounding internal thread 182 of opening 122. The ramping of the teeth and pockets provides for relatively easy installation and reliable retention of the fitting in the opening because the ramps are angled to allow tightening of the fitting in the opening, while opposing loosening. Thus a tool allowing for greater force may be necessary for the removal of the fitting from the opening. As will be described below, the large opening may include similar structure. The effect of this is for fittings that, on the one hand, are securely installed, and on the other hand, are also replaceable when that is needed. Thus, inlet and outlet hoses may be repeatedly installed and removed, and the eventual wear and tear on the fittings may lead to their replacement while the tank itself will still be usable with the new fittings.

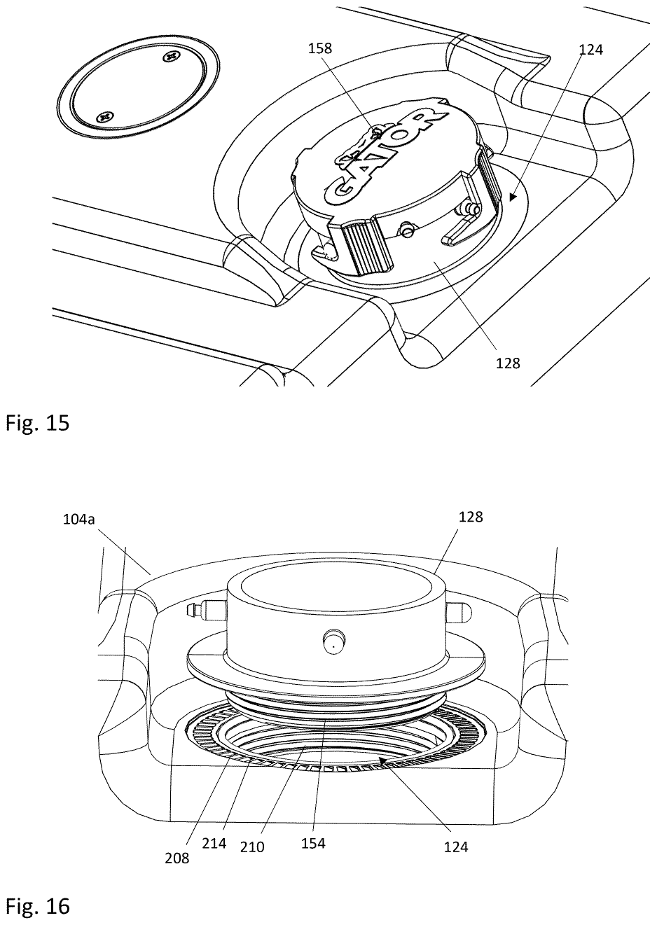

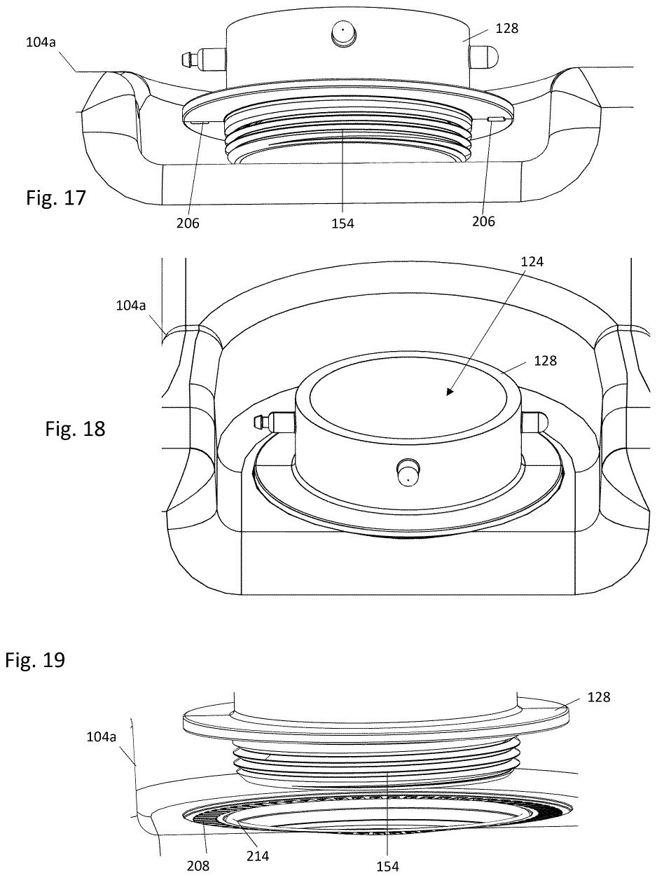

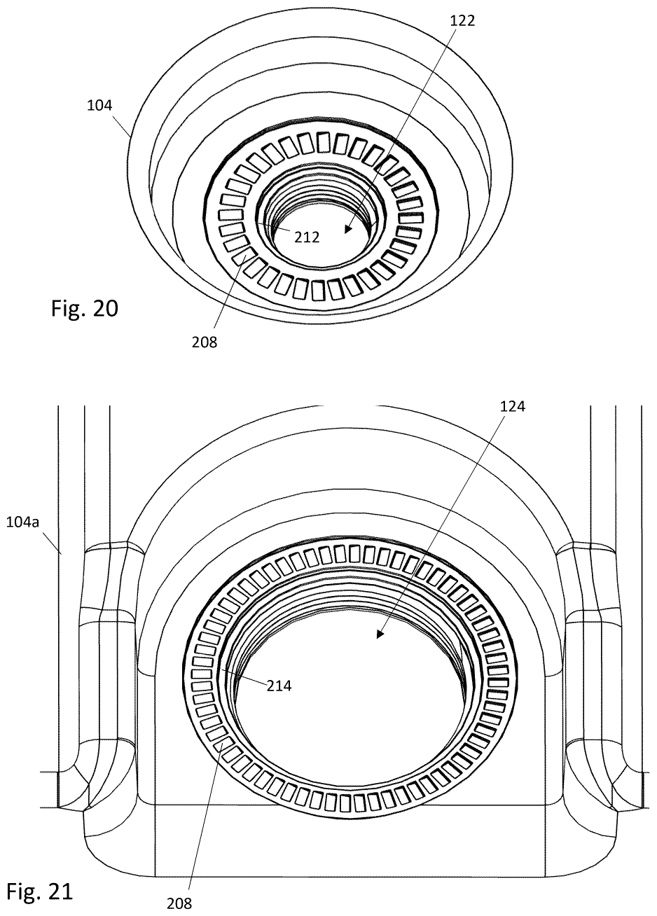

As best seen in FIGS. 15-21, large opening 124 may include fitting 128, which may be closed with cap 158. Opening 124 and fitting 128 may further include cooperating sets of teeth and pockets, e.g., a pair of ramped teeth 206 on fitting 128 (FIG. 17) and an annular set of ramped pockets 208 surrounding an internal thread 210 of opening 124 (FIGS. 19-21) to receive external thread 154 of fitting 128. As for the small opening, the ramping of the teeth and pockets provides for relatively easy installation and reliable retention of the fitting in the opening because the ramps are angled to allow tightening of the fitting in the opening, while opposing loosening. Thus a tool allowing for greater force may be necessary for the removal of fitting 128 from opening 124. For both of the openings on the tank, a standard internal pipe thread is typically used, so alternatively to the specific replaceable fittings described above, the user may install their own fitting suited to their particular application of the tank.

As best seen in FIGS. 12 and 19-21, each of the openings 122, 124 may include a sealing structure, such as O-rings 212, 214, respectively. The o-rings may provide for a watertight coupling of the fittings to the openings.

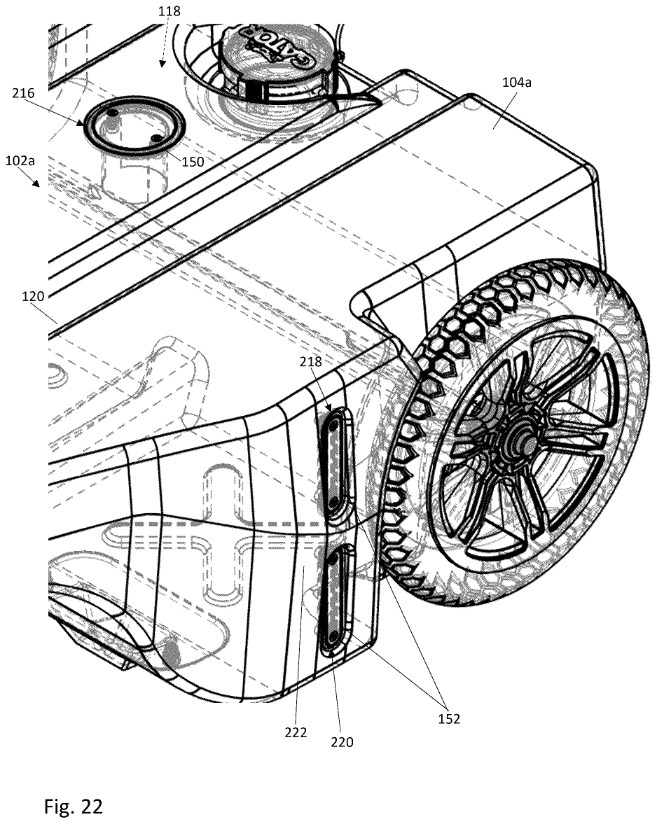

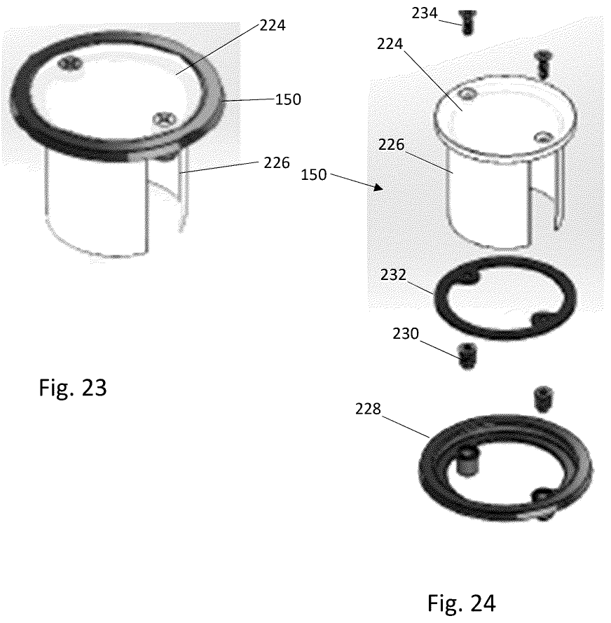

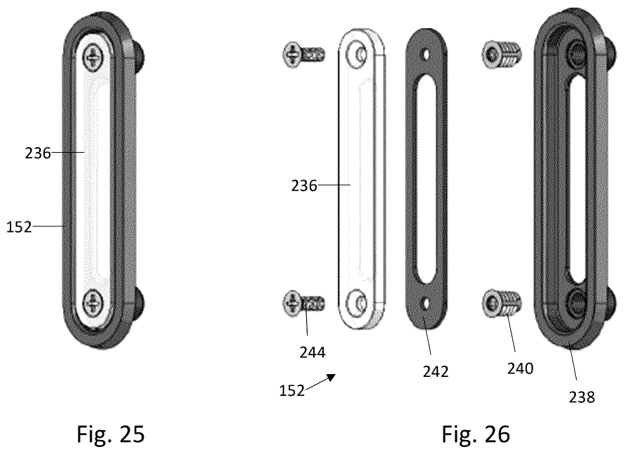

As best seen in FIGS. 22-26, gauges 150, 152 may be incorporated with the tank for a visual indication of the fill level. For example, an additional opening 216 (see also FIG. 9) may be provided in top portion 120 of the tank, which opening is then covered with the installation of gauge 150. Similarly, additional openings 218, 220 may be provided in a side 222 of the tank, which are closed by the installation of gauges 152.

Top gauge 150 may include a substantially transparent or translucent upper plate 224 integrally formed with a cylindrical portion 226 extending downwardly therefrom. Plate 224 may be installed over interior 118 at opening 216 and captively held in place with suitable hardware and sealing structure, such as rim 228, internally and externally threaded nut inserts 230, o-ring or gasket 232, and external screws 234 that screw into the internal threads of nuts 230, to provide a watertight installation of gauge 150. Alternative assembly techniques without nut inserts, screws, and/or gaskets may be used.

Similarly, each of side gauges 152 may include a substantially transparent or translucent plate 236. Plate 236 may be installed over interior 118 of the tank at opening 218 or 220 and captively held in place with suitable hardware and sealing structure, such as rim 238, internally and externally threaded nut inserts 240, o-ring or gasket 242, and external screws 244 that screw into the internal threads of nuts 240, to provide a watertight installation of each of gauges 152. Alternative assembly techniques without nut inserts, screws, and/or gaskets may be used. Also alternatively a single side gauge may be provided on the tank.

Plates 224, 236 are typically configured to be non-reflective where no liquid is present at an internal surface of the plate, and to be reflective where liquid is present. Gauges 150, 152 thus are configured to provide to the use a visual indication of the level of the liquid present in the tank.

1. A tank for handling a liquid, the liquid defining a weight, under operation by a user in a storage mode and in a transport mode on a surface, the tank comprising:
a. a body defining a front end in contact with the surface in the storage mode, a rear end, and an interior volume for receiving the liquid in the storage mode;
b. one or more wheels operatively coupled to the body adjacent the rear end of the body, the one or more wheels in contact with the surface in the storage mode and the transport mode; and
c. a handle coupled to the body adjacent the front end of the body, the handle operative for the user in the transport mode to lift the front end of the body off of the surface and to pull the tank along the surface with the one or more wheels remaining in contact with the surface, wherein the interior volume of the surface provides for storage of the liquid with the weight of the liquid concentrated adjacent the rear end of the body, and the weight of the liquid remains concentrated adjacent the rear end of the body as the user lifts the handle into the transport mode.

2. (canceled)

3. The tank of claim 1 wherein the body is formed as a plastic shell with the hollow interior.

4. The tank of claim 1 wherein the body further defines a top portion that includes one or more openings.

5. (canceled)

6. (canceled)

7. The tank of claim 4 wherein the one or more openings includes a small opening and further including a removable fitting attached to the small opening.

8. The tank of claim 4 wherein the one or more openings includes a large opening and further including a removable fitting attached to the large opening.

9. The tank of claim 4 wherein the one or more openings includes a small opening and a large opening and further including a first removable fitting attached to the small opening and a second removable fitting attached to the large opening.

10. The tank of claim 1 further wherein the one or more wheels are a pair of wheels mounted on an axle adjacent the rear end of the body and wherein the body defines a shape for the interior volume, and wherein the shape includes a major portion of the interior volume close to axle.

11. The tank of claim 10 further wherein the major portion include a first subportion subportions located fore of the axle and a second subportion located aft of the axle.

12. The tank of claim 11 wherein the shape includes a minor portion of the interior volume located close to the handle.

13. (canceled)

14. The tank of claim 1 wherein the interior volume is at least about gallons.

15. The tank of claim 1 wherein the interior volume is no more than about 16 gallons.

16. (canceled)

17. The tank of claim 1 wherein the front end of the body include at least one raised foot to rest on the surface in the storage mode.

18. A tank for handling a liquid, the tank providing for operation by a user in a storage mode and in a transport mode, the tank comprising:
a. a body defining a front end, a rear end, and an interior volume for receiving the liquid in the storage mode;
b. one or more wheels operatively coupled to the body for use in the transport mode;
c. a handle coupled to the body adjacent the front end of the body, the handle operative for the user in the transport mode to pull the tank with the aid of the one or more wheels; and
d. one or more gauges to provide the user with a visual indication of a level of the liquid in the tank for aid in determining when to transition from the storage mode to the transport mode.

19. The tank of claim 18 wherein the body is formed of a substantially opaque material and one or more gauges define one or more windows, wherein the one or more windows are at least substantially translucent.

20. (canceled)

21. The tank of claim 18 wherein the body further defines a top portion and wherein the one or more gauges includes a top gauge formed in the top portion.

22. The tank of claim 18 wherein the body further defines a side wall and wherein the one or more gauges includes a side gauge formed in the side wall of the body.

23. The tank of claim 22 further including a second side gauge formed in the side wall and wherein one of the side gauges is above the other.

24. A tank for handling a liquid, the tank providing for operation by a user in a storage mode and in a transport mode, the tank comprising:
a. a body defining a front end, a rear end, a top portion that includes at least one opening, and an interior volume for receiving the liquid in the storage mode;
b. one or more wheels operatively coupled to the body for use in the transport mode;
c. a handle coupled to the body adjacent the front end of the body, the handle operative for the user in the transport mode to pull the tank with the aid of the one or more wheels; and
d. a removable fitting attached to the at least one opening.

25. The tank of claim 24 further including a second opening in the top portion of the body, and a second removable fitting attached to the second opening.

26. (canceled)

27. The tank of claim 24 further including a hand-removable cap attachable to the at least one opening for use in the transport mode.

28. (canceled)
